(19) United States
(12) Patent Application Publication
(10) Pub. No.: US 2009/0012801 A1
(43) Pub. Date: Jan. 8, 2009

(54) Warranty service system

(75) Inventors: Shaw Hwa Hwang, Taipei City (TW); Kuo En Hung, Banciao City (TW)

Correspondence Address: BACON & THOMAS, PLLC, 625 SLATERS LANE, FOURTH FLOOR, ALEXANDRIA, VA, 22314-1176, US

(73) Assignee: Color City Enterprise Co., Ltd., Apia (WS)

(21) Appl. No.: 11/822,478

(22) Filed: Jul. 6, 2007

(51) Int. Cl. G06Q 50/00

(52) U.S. Cl. 705/1

(57) ABSTRACT

The present invention provides a warranty service system. It comprises a flash disk for warranty service, a computer, Internet and a registration center. The registration center is a computer server having a web address and a data base. A customer plugs the flash disk for warranty service into the computer and links with the registration center via Internet to achieve a warranty registration.

The warranty service system of the present invention further comprises an information center, which is a computer server having a web address and a data base. The information center has two functions: one is to provide product advertising information to the customer; the other is to connect a service phone of a company for the customer.

### FIELD OF THE INVENTION

The present invention relates to a warranty service system, and more particularly to a warranty service system utilizing flash disk, personal computer and Internet browser to register a warranty service.

### BACKGROUND OF THE INVENTION

Conventionally a company sells product to a customer, the company will give the customer a warranty card for the customer to fill in some basic information, and then mail it back to the company. After the company receives the warranty card, the company will put it into a filing system for management, and provide warranty service to the customer when necessary.

This kind of warranty card provides warranty service to the customer for a long time, but the customer has to keep a lot of warranty cards for different products, and the company has to set up a filing system for management, it is not very convenient to both the customer and the company.

Since flash disk, personal computer and Internet are very popular today, a new system for warranty service can be established for the customers and the companies to use the Internet platform to communicate with each other.

### SUMMARY OF THE INVENTION

The object of the present invention is to provide a warranty service system. It comprises a flash disk for warranty service, a computer, Internet and a registration center. A company sells product to a customer, the company will give the customer a flash disk for warranty service. The registration center is a computer server having a web address and a data base. The customer plugs the flash disk for warranty service into the computer and links with the registration center via Internet to achieve a warranty registration.

The warranty service system according to the present invention further comprises an information center, which is a computer server having a web address and a data base. The information center has two functions: one is to provide product advertising information to the customer; the other is to connect the service phone of the company for the customer.

The warranty service system for connecting the service phone of the company for the customer comprises the steps as below:

The information center packages the VoIP related software and the service phone number of the company into an ActiveX component, and applies a CodeSigning service from VeriSign company for conducting digital signature of the VoIP related software, then installs the ActiveX component to a related webpage of the company.

The customer plugs the flash disk for warranty service to a computer and links with the related webpage of the company in the data base of the information center via Internet, clicks the ActiveX component shown on the related webpage of the company, therefore downloads automatically the VoIP related software and the service phone number of the company to the computer of the customer, and then connects for the customer to the service phone of the company.

### BRIEF DESCRIPTION OF THE DRAWING

FIG. 1 shows schematically a flash disk for warranty service according to the present invention.

FIG. 2 shows schematically a registration center according to the present invention.

FIG. 3 shows schematically a real picture on the monitor of the computer for registering product warranty information.

FIG. 4 shows schematically an information center according to the present invention.

FIG. 5 shows schematically a block diagram for connection between a customer and a company service phone according to the present invention.

FIG. 6 shows schematically a real picture on the computer monitor for a customer to connect with a company service phone.

FIG. 7 shows schematically a real picture of the ActiveX component on the computer monitor.

### DETAILED DESCRIPTION OF THE PREFERRED EMBODIMENTS

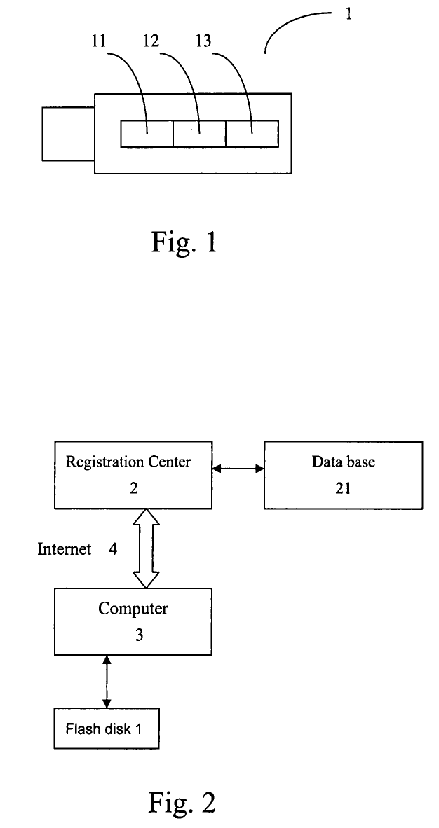

Referring to FIG. 1, a flash disk 1 for warranty service according to the present invention is shown. The flash disk 1 comprises three parts: an autorun part 11, a customer information part 12 and a free use part 13. A company sells product to a customer, the company will give the customer a flash disk 1 for warranty service.

The autorun part 11 includes programs for displaying related forms on a computer monitor and sending out customer warranty information to a registration center 2 when a customer plugs the flash disk 1 into a computer, please see FIG. 2. The customer information part 12 is used for storing the customer warranty information filled in through the related forms displayed on the computer monitor. The free use part 13 is just the same as an ordinary flash disk, and can be used by the customer freely.

A registration center 2 is set up according to the present invention, as shown in FIG. 2. The registration center 2 is a computer server having a web address. A customer plugs the flash disk 1 for warranty service into a computer 3 and links with the registration center 2 via Internet 4 to achieve a warranty registration. The registration center 2 has sufficient data base 21 for setting up customer warranty files for many companies and setting up warranty information for many customers. The registration center 2 can transfer the customer warranty files to the companies via Internet 4, and can accept the request from each customer to provide service.

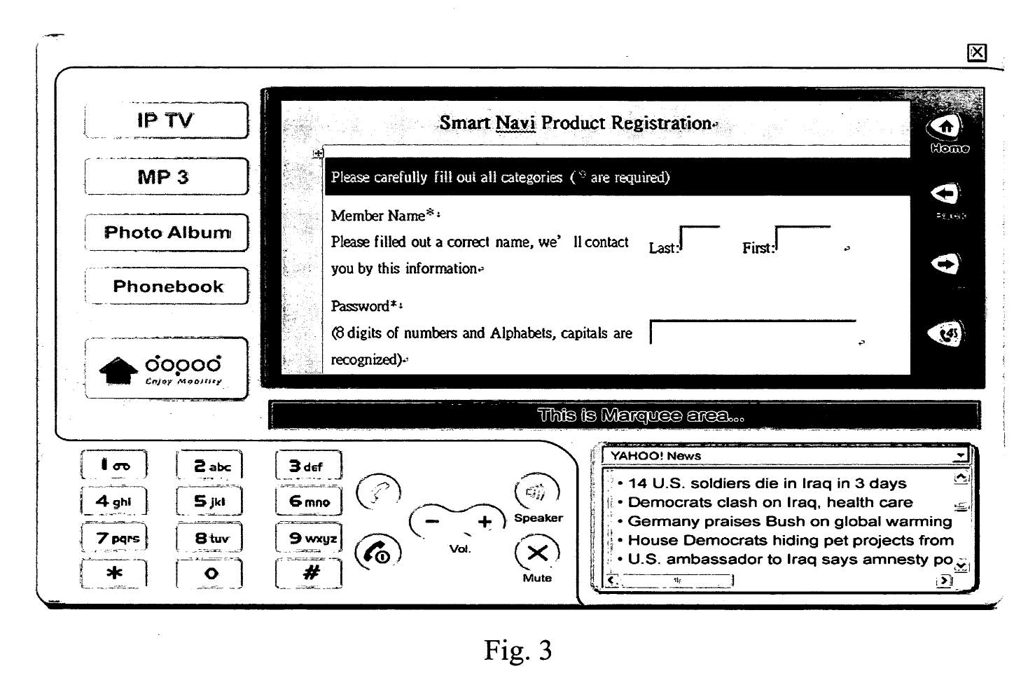

FIG. 3 shows schematically a real picture on the monitor of the computer for registering product warranty information when a customer plugs the flash disk 1 into the computer 3.

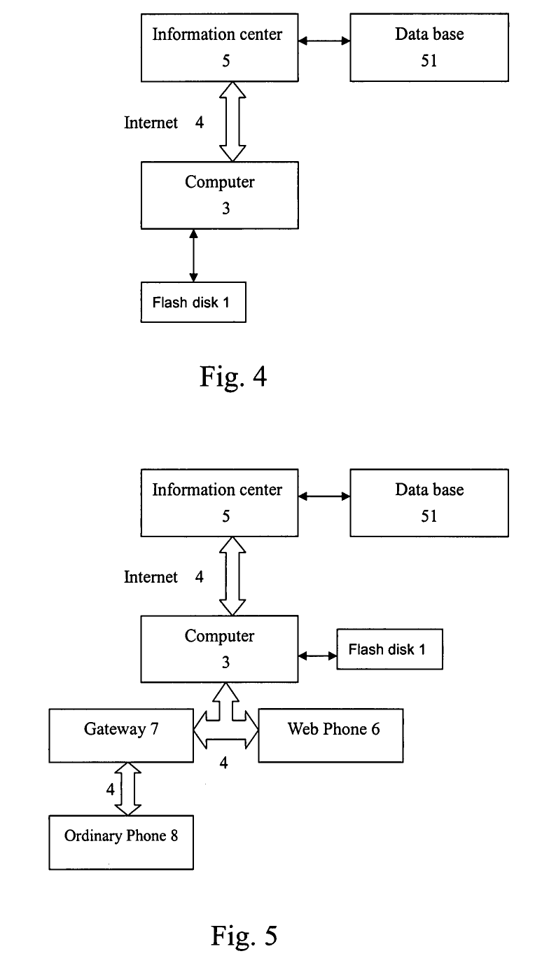

The present invention further sets up an information center 5, which is a computer server having a web address, as shown in FIG. 4. The information center 5 has two functions: one is to provide product advertising information to the customer; the other is to connect the service phone of the company for the customer.

FIG. 5 shows schematically a block diagram for connection between a customer and a company service phone according to the present invention. A customer plugs the flash disk 1 into a computer 3, and connects with a data base 51 of the information center 5 via Internet 4, clicks a related webpage of the company and then clicks the service phone number of the company, thereafter the information center 5 provides an automatic web call service via Internet browser, i.e. the information center 5 packages a VoIP related software and the service phone number of the company into an ActiveX component, and applies a CodeSigning service from VeriSign company for conducting digital signature of the VoIP related software, then installs the ActiveX component to a related webpage of the company. The customer clicks the ActiveX component shown on the related webpage of the company via Internet browser, therefore downloads automatically the VoIP related software and the service phone number of the company to the computer 3 of the customer, and then connects the customer to the service phone of the company.

If the service phone of the company is a web phone 6, then the information center 5 automatically directs the customer to the the web phone 6 of the company through the ActiveX component. If the service phone of the company is not a web phone, but an ordinary phone, then the information center 5 connects the ordinary phone 8 of the company via a gateway 7 to let the customer communicate with the service center of the company.

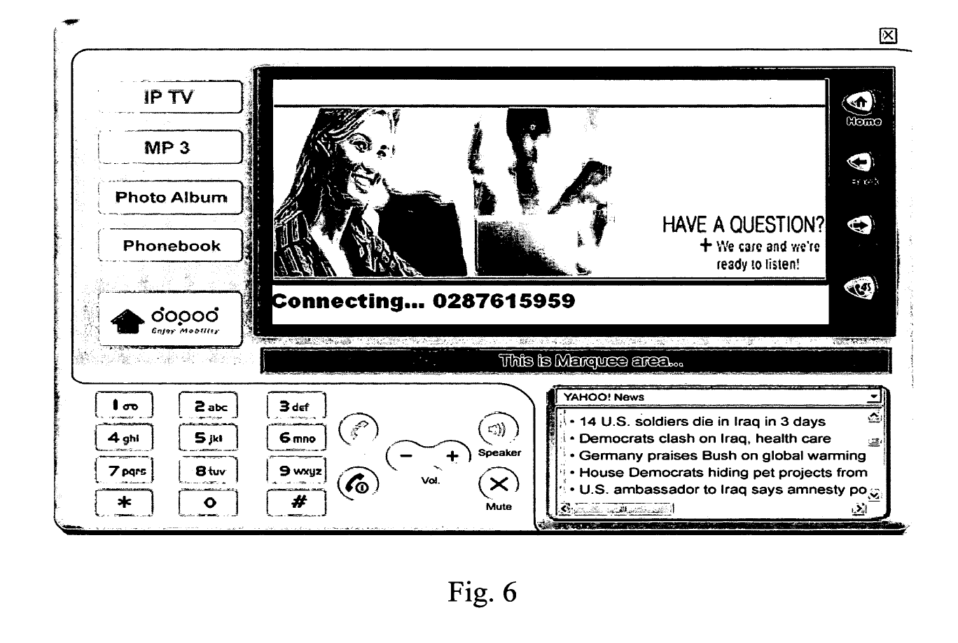

FIG. 6 shows schematically a real picture on the computer monitor for a customer to connect with a company service phone.

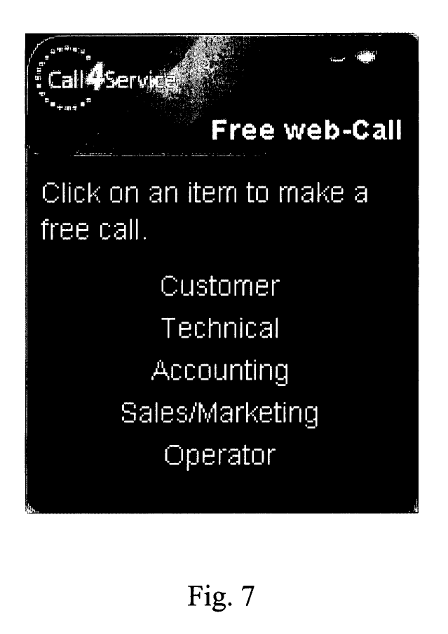

Another service type of the present invention is that a company sells product to a customer, the company will give the customer a flash disk 1 for warranty service. The autorun part 11 of the flash disk 1 has contained the ActiveX component packaged by the VoIP related software and the service phone number of the company. When a customer plugs the flash disk 1 into computer 3, the ActiveX component is automatically shown as the “Call4Service” in FIG. 7. After the customer clicks the ActiveX component, the customer is directed automatically to the service phone number of the company. If the customer wants to connect different departments of the company, clicks the name of the different departments in FIG. 7 to achieve connection.

The scope of the present invention depends upon the following claims, and is not limited by the above embodiments.

What is claimed is:

1. A warranty service system, comprising:
a flash disk for warranty service;
a computer;
a registration center, which is a computer server having a web address and a data base, and used by a customer to plug the flash disk for warranty service into the computer and links with the registration center via Internet to achieve a warranty registration.

2. The warranty service system according to claim 1, further comprises an information center, which is a computer server having a web address and a data base; the information center has two functions: one is to provide product advertising information to the customer; the other is to connect a service phone of a company for the customer.

3. The warranty service system according to claim 1, wherein the flash disk for warranty service comprises three parts:
an autorun part, which includes programs for displaying related forms on a monitor of the computer and sending out customer warranty information to the registration center when the customer plugs the flash disk for warranty service into the computer;
a customer information part, which is used for storing the customer warranty information filled in through the related forms displayed on the monitor of the computer;
a free use part, which is just the same as an ordinary flash disk, and can be used by the customer freely.

4. The warranty service system according to claim 1, wherein the registration center is used for setting up customer warranty files for many companies and setting up warranty information for many customers; the registration center can transfer the customer warranty files to the companies via Internet, and can accept a request from each customer to provide service.

5. The warranty service system according to claim 2, wherein the the function to connect a service phone of a company for the customer comprises the following steps:
the information center packages a VoIP related software and a service phone number of the company into an ActiveX component, and applies a CodeSigning service from VeriSign company for conducting digital signature of the VoIP related software, then installs the ActiveX component to a -related webpage of the company.
the customer plugs the flash disk for warranty service into the computer and connects with the data base of the information center via Internet, clicks the related webpage of the company and then clicks the ActiveX component shown on the related webpage of the company, therefore downloads automatically the VoIP related software and the service phone number of the company to the computer, and then connects the customer to the service phone of the company.

6. The warranty service system according to claim 5, wherein if the service phone of the company is a web phone, then the information center automatically directs the customer to the the web phone of the company through the ActiveX component; if the service phone of the company is not a web phone, but an ordinary phone, then the information center connects the ordinary phone of the company via a gateway to let the customer communicate with the company.

7. The warranty service system according to claim 3, wherein the autorun part of the flash disk for warranty service has contained an ActiveX component packaged by a VoIP related software and a service phone number of a company, when the customer plugs the flash disk for warranty service into the computer, the ActiveX component is automatically shown; after the customer clicks the ActiveX component, the customer is directed automatically to the service phone number of the company.
